(19) United States
(12) Patent Application Publication
(10) Pub. No.: US 2014/0144883 A1
(43) Pub. Date: May 29, 2014

(54) Gas Circuit Breaker

(71) Applicant: Hitachi, Ltd., Tokyo (JP)

(72) Inventors: Hisashi URASAKI, Tokyo (JP); Masanori TSUKUSHI, Tokyo (JP)

(73) Assignee: Hitachi, Ltd., Tokyo (JP)

(21) Appl. No.: 14/084,065

(22) Filed: Nov. 19, 2013

(30) Foreign Application Priority Data
Nov. 29, 2012 (JP) 2012-260468

(51) Int. Cl. H01H 33/42

(52) U.S. Cl. CPC H01H 33/42
USPC 218/84

(57) ABSTRACT

A gas circuit breaker includes a circuit-breaking portion provided within a tank. The tank is filled with insulating gas and disposed in an upright position. The circuit-breaking portion is connected to a bus through a main circuit conductor. The circuit-breaking portion has an operation unit disposed outside the tank. The operation unit is an electric linear motor operation unit composed of a driving portion and a driving energy storage portion. The driving portion is adjacent to the tank. The driving energy storage portion is separated from the driving portion. The driving energy storage portion and the driving portion are electrically connected.

### BACKGROUND

The present invention relates to a gas circuit breaker (hereinafter referred to as GCB), and more particularly, to a GCB which allows miniaturization of a gas-insulated switchgear (hereinafter referred to as GIS).

In recent power switching apparatuses, responding to the increase in power demand and the needs for miniaturization and high reliability of power equipment, there has been a remarkable tendency to mainly use a GIS, in which an electrical apparatus, such as a live conductor or a circuit-breaking portion, is stored within a tank filled with sulfur hexafluoride (SF₆) gas having high insulation and interruption performance, thereby significantly reducing the whole size of the electrical apparatus.

The most important element of the GIS is a GCB. The GCB has a structure in which a circuit-breaking portion is supported through an insulating spacer within the sealed tank containing the SF₆ gas.

The circuit-breaking portion is driven at a high speed so as to quickly interrupt not only a load current at normal time but also a short circuit large-current at a fault. The driving energy thereof is large, and, in the related art, a large-sized operation unit is mounted outside a circuit-breaking portion tank and driven by hydraulic pressure or spring force.

All the hydraulic pressure or spring force other than by a pump or motor is generated by the control or amplification action of a mechanical system or high pressure fluid system. Therefore, the operation unit is increased in size and occupies a considerable portion of the elements of the GCB.

In particular, the operation unit is mounted at an end or lower portion of the circuit breaking portion tank to fulfill its purpose, which causes an increase in the overall length and overall height of the GCB. In the related art, upright breakers are used in order to meet a request for reducing an installation area. In the related art breakers, separately locating a driving energy storage portion (an accumulator or a driving spring) and a driving portion should be avoided for efficient transmission of the driving energy.

For example, in an upright breaker disclosed in Japanese Unexamined Patent Application Publication No. H10(1998)-174229, because the driving portion and the driving energy storage portion cannot be separately located as described above, the operation unit must be installed at a lower portion of the circuit-breaking portion tank, and it becomes necessary to raise the overall height of the GCB. This is contrary to a reduction in the size and height of the GIS, and further causes the problems, such as an increase in the height of the center of gravity of the GIS as a whole and deterioration in earthquake resistance.

### SUMMARY

Although reduction in the overall length, overall height, and overall width of the GCB is essential to reduce the size and height of the GIS, there is a limit on the miniaturization because the size of the circuit-breaking portion tank depends on a large fault current high-speed interrupting function which is the largest role of the GCB. Therefore, while miniaturization of the operation unit is desired, it currently has limitations.

That is because, in the operation unit requiring high speed and high output, all elements around an operation output shaft must be put into one place because most of systems are composed of the mechanical system or fluid system, and further the transmission efficiency or transmission speed of mechanical power or hydraulic power is important.

That is, the miniaturization of the operation unit main body can be achieved if the above-described accumulator or driving spring can be separated from the operation unit, however, it has been difficult because there are many problems, such as transmission efficiency and transmission speed of operation force.

Accordingly, in view of the foregoing, an object of the present invention is to achieve a reduction in the height of an upright GCB, and, by extension, the height of a GIS, with an operation unit having a high degree of freedom of arrangement.

To address the above-mentioned problems, according to an aspect of the present invention, a gas circuit breaker includes a circuit-breaking portion provided within a tank. The tank is filled with insulating gas and disposed in an upright position. The circuit-breaking portion is connected to a bus through a main circuit conductor. The circuit-breaking portion is driven by an operation unit provided outside the tank. The operation unit is an electric linear motor operation unit composed of a driving portion and a driving energy storage portion. The driving portion is adjacent to the tank. The driving energy storage portion is separated from the driving portion. The driving energy storage portion and the driving portion are electrically connected.

With the electric linear motor operation unit according to the aspect of the present invention, the degree of freedom of arrangement of the driving energy storage portion can be increased. Thus, the driving energy storage portion and the driving portion, which need to be integrated with each other in the related art, can be separated from each other and disposed at respective optional positions, thereby allowing a reduction in the height of the upright GCB, and, by extension, the height of the GIS.

### BRIEF DESCRIPTION OF THE DRAWINGS

FIG. 1 is a configuration diagram of a GIS including a GCB according to a first embodiment of the present invention;

FIG. 2 is a detail view of the GCB according to the first embodiment;

FIG. 3 is a sectional view showing one unit of an actuator according to the first embodiment;

FIG. 4 is a perspective view of the actuator according to the first embodiment;

FIG. 5 is a front view of FIG. 4;

FIG. 6 is a diagram with a winding removed from FIG. 5;

FIG. 7 is a perspective view for explaining the actuator according to the first embodiment;

FIG. 8 is a sectional view of FIG. 7; and

FIG. 9 is a schematic diagram showing another embodiment of the present invention;

### DETAILED DESCRIPTION

Hereinafter, an embodiment of the present invention will be described with reference to the accompanying drawings.

### First Embodiment

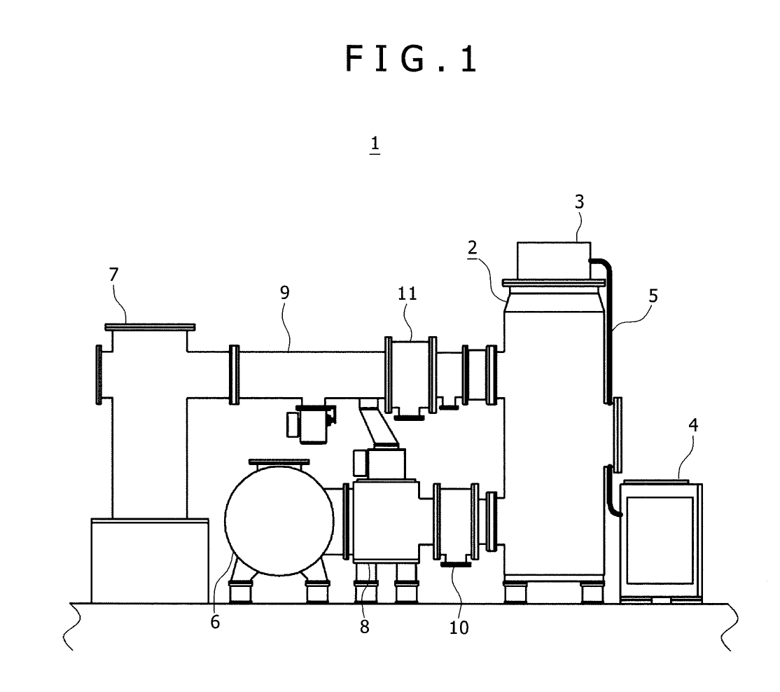

FIG. 1 is a side view of a GIS including an upright GCB according to a first embodiment of the present invention. A gas circuit breaker 2 having a circuit-breaking portion disposed therein has a lower connection connected to a bus disconnecting switch 8 through an instrument transformer 10 and then connected to a main bus 6.

The gas circuit breaker 2 has an upper connection connected to a line disconnecting switch 9 through an instrument transformer 11 and then connected to a cable head 7.

Referring to FIG. 1, an operation unit (driving portion) 3 is disposed at an upper portion of the gas circuit breaker 2, and an operation unit (driving energy storage portion) 4, when connected to the gas circuit breaker 2, is disposed separately from the gas circuit breaker 2 through a control power cable 5.

In this embodiment, with this configuration, the operation units can be dividedly disposed, thereby enabling lowering the overall height, as compared with the related art upright breaker in which the whole operation unit is disposed at an upper or lower end of a tank. Consequently, the height of the upright GCB, and, by extension, the height of the GIS can be reduced.

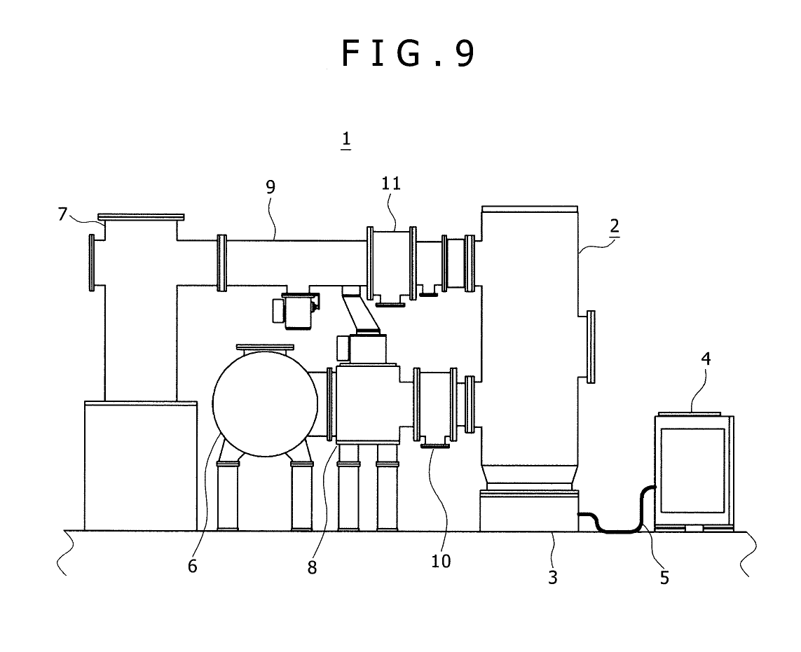

It should be noted that the same advantage can be obtained also in another embodiment of the present invention, as shown in FIG. 9, in which the operation unit (driving portion) 3 is disposed at a lower end of the gas circuit breaker 2. It should be also noted that the position of the operation unit (driving portion) 3 is not limited to the upper or lower end of the gas circuit breaker 2 and can be any position adjacent to the gas circuit breaker 2 which allows the transmission of driving force of the operation unit (driving portion) 3 to the circuit-breaking portion.

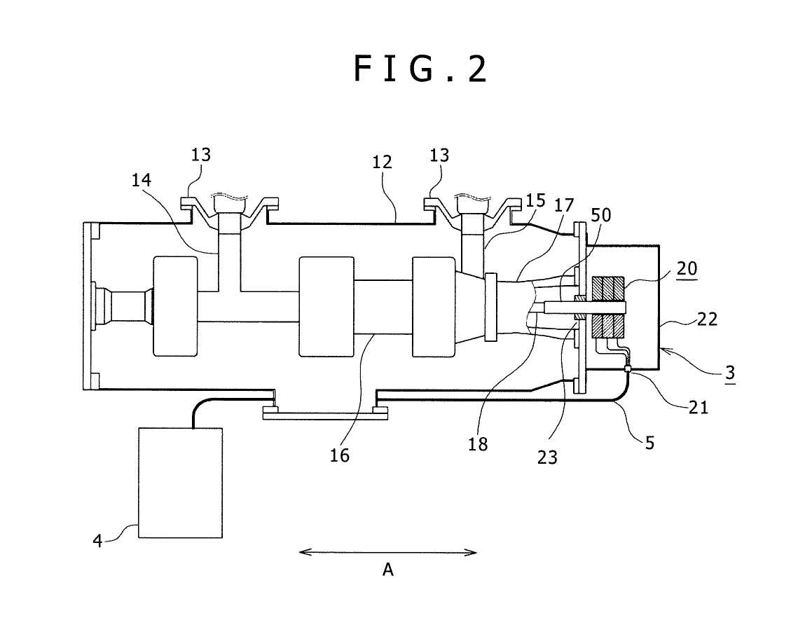

FIG. 2 is an internal structure diagram of the gas circuit breaker 2. The circuit-breaking portion has: a fixed side electrode 14 and a movable side electrode 15 that are provided in a tank 12 filled with SF₆ gas and each fixed to an insulating support spacer 13; an insulating support cylinder 17 that supports the movable side electrode 15; a movable electrode 16; and an insulating rod 18 connected to the movable electrode 16. The circuit-breaking portion is electrically opened and connected by moving the movable electrode 16 in a direction of arrow A in the figure (hereinafter referred to as the A direction) through operating force from an operation portion, thereby allowing current interruption and energization.

The operation unit (driving portion) 3 has an electric actuator 20 within an operation unit case 22 provided at an upper end of the tank 12. A mover 50 is disposed within the electric actuator 20 to move linearly in the A direction.

The mover 50 is connected to the insulating rod 18 through a gas seal unit 23. The gas seal unit 23 is provided for allowing the driving of the mover 50 with the tank 12 kept airtight. That is, movement of the mover 50 allows the movement of the movable electrode 16 in the A direction in the circuit-breaking portion.

The electric actuator 20 is electrically connected to the control power cable 5 through a sealing terminal 21. The sealing terminal 21 is provided for allowing the wire connection of the electric actuator 20 to the outside of the operation unit case 22 with the operation unit case 22 kept airtight.

The control power cable 5 is connected to the operation unit (driving energy storage portion) 4 so that the electric actuator 20 receives a command and current from the operation unit (driving energy storage portion) 4.

The operation unit (driving energy storage portion) 4 serves as a control mechanism for changing the amount or phase of current to be supplied to the electric actuator 20 according to the current values detected by the instrument transformers 10 and 11.

The electric actuator 20 generates a magnetic field therein with a current supplied from the operation unit (driving energy storage portion) 4 to cause the mover 50 disposed within the electric actuator 20 to drive linearly with electromagnetic force.

Because the size or direction of the thrust force acting on the mover 50 can be changed by controlling a command and current supplied from the operation unit (driving energy storage portion) 4, the drive speed or stop position of the circuit-breaking portion can be optionally controlled by a command from the operation unit (driving energy storage portion) 4.

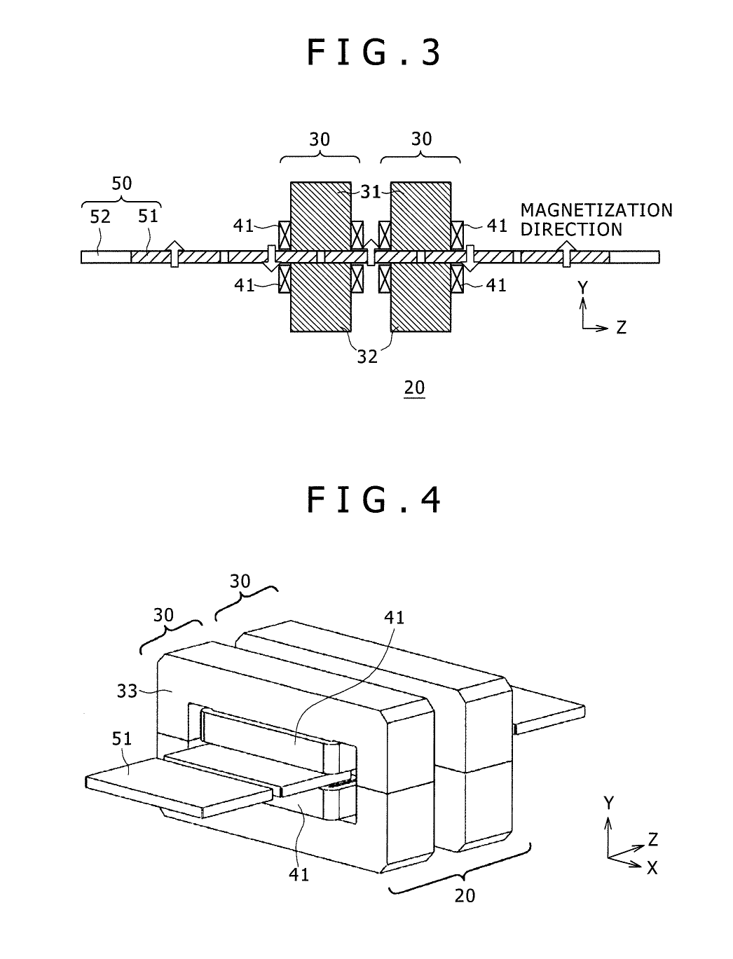

Hereinafter, a concrete construction of the electric actuator 20 will be described. As shown in FIGS. 3 to 6, the electric actuator 20 includes a pair of stators 30 each composed of: a first magnetic pole 31; a second magnetic pole 32 opposed to the first magnetic pole 31; a magnetic body 33 connecting the first and second magnetic poles 31 and 32; and a winding 41 provided at an inner periphery of each of the first and second magnetic poles 31 and 32. Within the pair of stators 30, the mover 50 is disposed at a position facing the first and second magnetic poles 31 and 32 through a gap. The mover 50 is composed of permanent magnets 51 and magnet fixing members 52 for supporting the permanent magnets 51 while holding the permanent magnets 51 therebetween.

The permanent magnets 51 are magnetized in a Y direction (vertical direction in FIG. 3), and magnetized alternately for every adjacent magnets. Preferably, the magnet fixing members 52 are made of a non-magnetic material, such as a nonmagnetic stainless steel alloy, aluminum alloy, or resin material, but are not limited thereto.

The actuator 20 is mounted with a mechanical component for keeping a spacing between the permanent magnets 51 and each of the first and second magnetic poles 31 and 32. For example, the mechanical component is preferably a linear guide, roller bearing, cam follower, thrust bearing or the like, but is not limited thereto if a spacing between the permanent magnets 51 and each of the first and second magnetic poles 31 and 32 is kept.

At the time of driving, a magnetic field is generated by applying a current to the winding 41, and thrust corresponding to a relative position between the stators 30 and the permanent magnets 51 can be generated. Furthermore, the size and direction of thrust can be adjusted by controlling the positional relationship between the stators 30 and the permanent magnets 51 and the phase and magnitude of a current to be injected.

FIG. 4 shows a perspective view of the construction of one unit of the above-described actuator 20. As shown in FIG. 4, the mover 50 having the permanent magnets 51 moves in a Z direction relatively to the pair of stators 30 each composed of the first magnetic pole 31, the second magnetic pole 32, the magnetic body 33 connecting the first and second magnetic poles 31 and 32, and the winding 41. The plurality of permanent magnets 51 are mechanically coupled by the magnet fixing members 52 or the like, thereby continuously providing thrust in the Z direction and allowing the switching action of the mover 50.

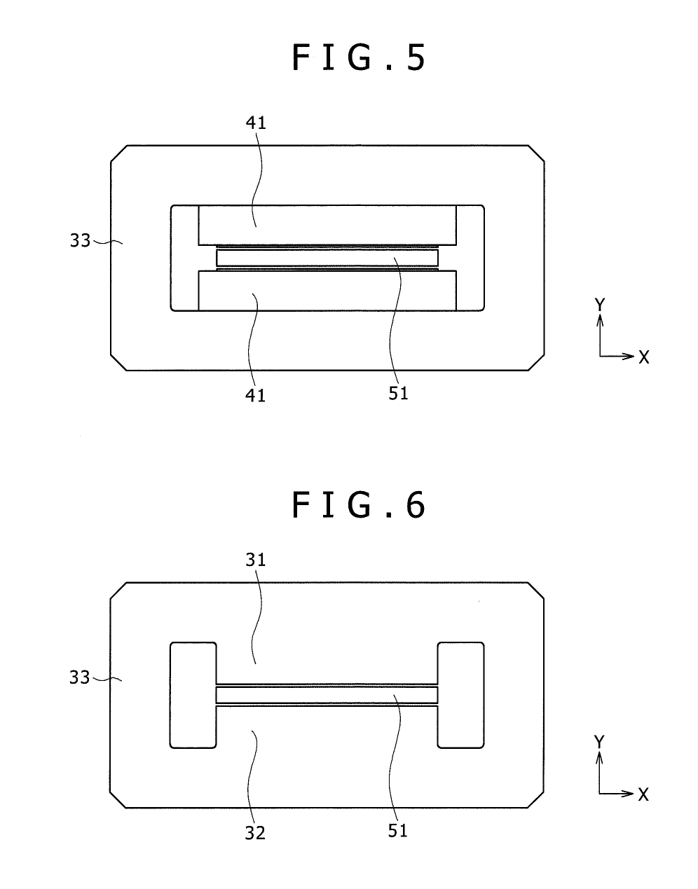

FIG. 5 is a front view of FIG. 4. FIG. 6 is a diagram with the winding 41 deleted from FIG. 5 in order to facilitate understanding of the relationship among the first magnetic pole 31, the second magnetic pole 32, and the magnetic body 33 connecting the first and second magnetic poles 31 and 32.

As can be seen from FIGS. 4 and 5, the winding 41 is wound on each of the first magnetic pole 31 and the second magnetic pole 32 and disposed in such a manner as to hold the permanent magnets 51 in between. Since the winding 41 and the permanent magnets 51 are opposed to each other, a magnetic flux generated in the winding 41 efficiently acts on the permanent magnets 51. Thus, the actuator 20 can be reduced in size and weight.

Further, a magnetic circuit is closed by the first magnetic pole 31, the second magnetic pole 32, and the magnetic body 33 connecting the first and second magnetic poles 31 and 32, thereby allowing shortening of a magnetic circuit path. Thus, large thrust can be generated. Also, the permanent magnets 51 are covered with a magnetic body, thereby allowing reduction of flux leakage to the outside and reduction of influence on peripheral equipment.

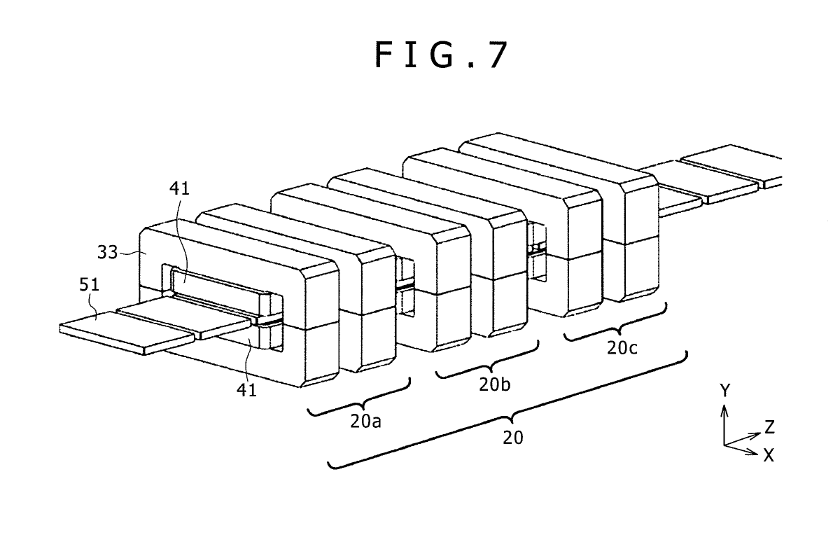

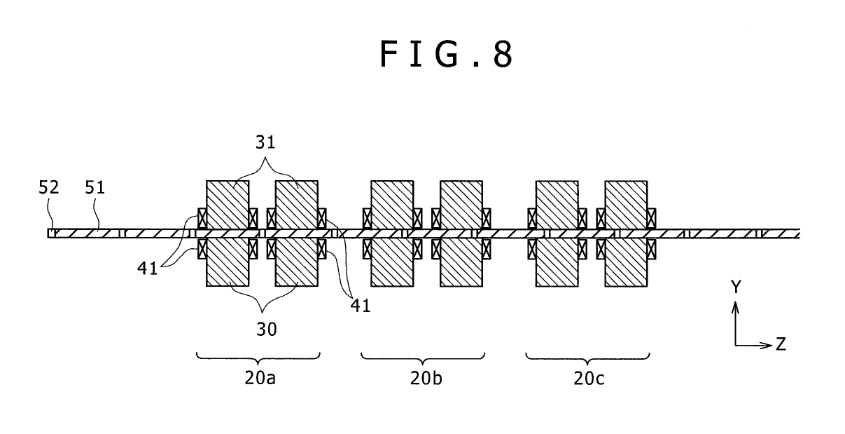

The electric actuator 20 according to this embodiment will be described with reference to FIGS. 7 and 8. In this embodiment, the electric actuator 20 is composed of three units of actuators 20a, 20b, and 20c arranged in the Z direction (direction of the motion axis of the movable electrode 16). In this embodiment, as described above, one unit may be composed of two stators, and the three units of electric actuators 20a, 20b, and 20c may be composed of the stators whose number is three times as many as the stators constituting one unit.

The three units of actuators 20a, 20b, and 20c are shifted in electric phase with respect to the permanent magnets 51. In this embodiment, one unit is composed of the two stators, and the three units of actuators 20a, 20b, and 20c are composed of the six stators in total.

Furthermore, the actuator 20b and the actuator 20c are shifted in electric phase by 120° and 240°, respectively, with respect to the actuator 20a.

With this actuator arrangement, the same operation as a three-phase linear motor can be achieved by applying three phase currents to the windings 41 of the actuators 20a, 20b, and 20c. Using the three units of actuators 20a, 20b, and 20c allows thrust adjustment by individual current control of each of the actuators, as three independent actuators.

Currents having different sizes or phases can be injected into the respective windings of the actuators 20a, 20b, and 20c from the operation unit (driving energy storage portion). In this embodiment, three phase currents U, V, and W from a single AC current are separately supplied, thereby eliminating the need for a plurality of power sources and allowing a simple configuration.

With the electric linear motor operation unit according to embodiments of the present invention as shown above, the degree of freedom of arrangement of the driving energy storage portion of the GCB can be increased. Thus, the driving energy storage portion and the driving portion of the operation unit, which need to be integrated with each other in the related art, can be separated from each other and disposed at respective optional positions. Consequently, the GCB can be reduced in height, and reduction in the overall height and height of the center of gravity of the whole GIS can be achieved.

What is claimed is:

1. A gas circuit breaker comprising:
a circuit-breaking portion provided within a tank, the tank being filled with insulating gas and disposed in an upright position, the circuit-breaking portion being connected to a bus through a main circuit conductor, the circuit-breaking portion being driven by an operation unit provided outside the tank,
wherein the operation unit is an electric linear motor operation unit composed of a driving portion and a driving energy storage portion, the driving portion being adjacent to the tank, the driving energy storage portion being separated from the driving portion, the driving energy storage portion and the driving portion being electrically connected.

2. The gas circuit breaker according to claim 1,
wherein the driving portion includes:
a mover composed of a plurality of integrally-formed permanent magnets or magnetic materials arranged with magnetization directions alternately inverted; and
a stator composed of first and second magnetic poles arranged to hold the mover therebetween from upper and lower sides, a magnetic body connecting the first and second magnetic poles to form a magnetic flux path, and a winding wound around each of the first and second magnetic poles,
wherein the driving energy storage portion changes an amount of current to be supplied to the winding according to a current value detected by a current detector for detecting a current flowing through the main circuit conductor.

3. The gas circuit breaker according to claim 2,
wherein the stators whose number is integer three times as many as the stators constituting one unit are disposed in a moving direction of the mover, and
wherein the winding is shifted in electric phase by 120° for each unit of the adjacent stators, and operation as a three-phase linear motor is achieved by applying three phase currents to the windings.

4. The gas circuit breaker according to claim 1, wherein the driving portion is disposed at an upper end of the tank.

5. The gas circuit breaker according to claim 2, wherein the driving portion is disposed at an upper end of the tank.

6. The gas circuit breaker according to claim 3, wherein the driving portion is disposed at an upper end of the tank.

7. The gas circuit breaker according to claim 1, wherein the driving portion is disposed at a lower end of the tank.

8. The gas circuit breaker according to claim 2, wherein the driving portion is disposed at a lower end of the tank.

9. The gas circuit breaker according to claim 3, wherein the driving portion is disposed at a lower end of the tank.
